(19) United States
(12) Patent Application Publication
(10) Pub. No.: US 2026/0094310 A1
(43) Pub. Date: Apr. 2, 2026

(54) GENERATION OF SYNTHETIC FAULT IMAGES OF SEMICONDUCTOR SPECIMENS

(71) Applicant: Applied Materials Israel Ltd., Rehovot (IL)

(72) Inventors: Boris SHERMAN, Rehovot (IL); Boris LEVANT, Rehovot (IL); Ran BADANES, Rishon Le-Zion (IL); Ran YACOBY, Jerusalem (IL); Bar DUBOVSKI, Beit Hashmonay (IL); Tomer YEMINY, Givat Shmuel (IL)

(21) Appl. No.: 18/902,793

(22) Filed: Sep. 30, 2024

(51) Int. Cl. G06T 11/00; G06T 7/00; G06V 10/774

(52) U.S. Cl. CPC G06T 11/00; G06T 7/0008; G06V 10/774; G06T 2207/10061; G06T 2207/30148

(57) ABSTRACT

The presently disclosed subject matter includes a computer system and a computer-implemented method of generating synthetic examination output images, including synthetic fault images and synthetic fault-free images. The synthetic fault images comprise artificially generated 3D defects. The proposed technique enables fast, accurate, and efficient generation of a large and diverse collection of synthetic fault images and fault-free images, which can be implemented in runtime, as part of the examination process of semiconductor specimens.

### TECHNICAL FIELD

The presently disclosed subject matter is related to fabrication and examination of semiconductor specimens.

### BACKGROUND

Current demands for high density and performance associated with the ultra-large-scale integration of fabricated devices require submicron features, increased transistor and circuit speeds, and improved reliability. As semiconductor processes advance, pattern dimensions such as line width, along with other critical dimensions, are continuously reduced. These demands necessitate the formation of device features with high precision and uniformity, which, in turn, requires meticulous monitoring of the fabrication process, including automated examination of devices while they are still in the form of semiconductor wafers.

Semiconductor examination is a crucial part of the semiconductor manufacturing process, involving the inspection of semiconductor wafers for defects of interest (DOIs) to ensure quality. DOIs may arise from various factors, including manufacturing process errors, material imperfections, contamination during fabrication, or equipment malfunctions. This process employs advanced technologies such as optical microscopy, electron microscopy, and automated scanning systems to identify defects like cracks, misalignments, or impurities. These imperfections can significantly impact the yield rate and the performance of the final product. Even the smallest fault in a semiconductor can severely affect the functionality of electronic devices such as computers, smartphones, and other digital equipment, making this inspection process essential for maintaining the reliability and efficiency of electronic components. Additionally, effective defect detection reduces manufacturing costs and waste, as undetected defects can lead to substantial resource loss.

### GENERAL DESCRIPTION

The presently disclosed subject matter contemplates a method and system for generating synthetic fault images (e.g., synthetic SEM images) that contain at least one synthetic 3D defect.

According to a first aspect of the presently disclosed subject matter there is provided a computer-implemented method of generating synthetic images of a semiconductor examination tool (synthetic SEM images); the method comprising (utilizing a processing circuitry for):
obtaining one or more examination output images (e.g., real NVDs) of a semiconductor specimen acquired by the semiconductor examination tool;
processing the one or more examination output images using a height map generation algorithm dedicated to generating, from each image, a respective height map of the semiconductor specimen, thereby obtaining one or more height maps;
modifying at least some of the one or more height maps to include at least one artificially generated three-dimensional (3D) defect, thereby generating one or more respective synthetic fault height maps;
applying a first machine learning model to the one or more respective synthetic fault height maps, wherein the first machine learning model is trained to generate, from height maps of a semiconductor specimen, corresponding synthetic images of the semiconductor specimen, thereby obtaining one or more respective synthetic fault images (e.g., synthetic fault SEM images).

In addition to the above features, the method according to this aspect of the presently disclosed subject matter can optionally comprise one or more of features (i) to (ix) below, in any technically possible and technically possible combination or permutation:
i. Wherein the one or more examination output images includes one or more fault-free images, the method further comprising:
   processing the one or more fault-free images using a height map generation algorithm dedicated to generating, from each image, a respective height map of the semiconductor specimen, thereby obtaining one or more height maps;
   applying the first machine learning model to the one or more height maps, thereby obtaining one or more respective synthetic fault-free images.
ii. Wherein generation of synthetic fault images is executed as part of a defects detection process, dedicated for detecting defects in examination output images of a semiconductor specimen; the method comprising executing, as part of the defects detection process:
   generating a training dataset from the synthetic fault images and the fault-free images;
   utilizing the training dataset for training a second machine learning model dedicated for receiving examination output images of a semiconductor specimen and detecting defects therein.
iii. Wherein generation of synthetic fault images and synthetic fault-free images is executed as part of a defects detection process, dedicated for detecting defects in examination output images of a semiconductor specimen; the method comprising executing, as part of the defects detection process, operations comprising:
   generating a training dataset from the synthetic fault images and synthetic fault-free images;
   utilizing the training dataset for training a second machine learning model dedicated for receiving examination output images of a semiconductor specimen and detecting defects therein.
iv. The computer-implemented method further comprising: following training of the second machine learning model, applying a second machine learning model to scan output images of the semiconductor specimen acquired by the semiconductor examination tool, thereby detecting defects in the semiconductor specimens.
v. Wherein the defects detection process is executed as part of a semiconductor fabrication process for detecting defects in real-time.
vi. The computer-implemented method further comprises:
   responsive to receiving data indicating that examination output images of a semiconductor specimen contain a type of defect that was not included in a training set used for training the second machine learning model, executing the defects detection process, where the at least one artificially generated three-dimensional (3D) defect includes the type of defect, thereby updating the second machine learning model to detect the type of defect, on-the-fly.
vii. Wherein the first machine learning model is configured to generate synthetic fault images labeled to indicate existence of defects and synthetic fault-free images labeled to indicate absence of defects.
viii. Wherein modifying each height map to include at least one artificially generated 3D defect comprises applying procedural generation methods (e.g., Perlin noise and Voronoi noise) for creating a 3D defect, and implanting the 3D defect in the height maps.
ix. Wherein the examination tool includes any suitable examination tool, including, for example, a Scanning Electron Microscope (SEM), in which case the images which are processed are SEM images of the semiconductor specimen.

According to a second aspect of the presently disclosed subject matter there is provided a computer system for automatic generation of synthetic images of a semiconductor examination tool, the system comprising a processing circuitry configured to execute the method of the first aspect above.

According to a third aspect of the presently disclosed subject matter there is provided a non-transitory computer readable medium comprising instructions that, when executed by a computer, cause the computer to perform a method according to the first aspect above.

According to a fourth aspect of the presently disclosed subject matter there is provided a computer-implemented method of defect detection in a semiconductor specimen, the method comprising (utilizing at least one processing circuitry for) executing a defects detection process comprising:
obtaining examination output images of the semiconductor specimen acquired by a semiconductor examination tool;
processing the examination output images using a height map generation algorithm dedicated to generating, from each image, a respective height map of the semiconductor specimen, thereby obtaining respective height maps;
modifying at least some of the respective height maps to include at least one artificially generated three-dimensional (3D) defect, thereby generating respective synthetic fault height maps;
applying a first machine learning model to the respective synthetic fault height maps and to one or more fault-free height maps, wherein the first machine learning model is trained to generate, from height maps of a semiconductor specimen, corresponding synthetic images of the semiconductor specimen, thereby obtaining a group of synthetic fault images and synthetic fault free images;
generating a training dataset from the group of synthetic fault images and synthetic fault free images;
utilizing the training dataset for training a second machine learning model dedicated for receiving examination output images of a semiconductor specimen and detecting defects therein; and
following training of the second machine learning model, applying the second machine learning model to other examination output images of the semiconductor specimen acquired by the semiconductor examination tool, thereby detecting defects in the semiconductor specimens.

According to a fifth aspect of the presently disclosed subject matter there is provided a computer-implemented method of generating a training dataset for training a machine learning model dedicated for detecting defects in examination output images of a semiconductor specimen generated by a semiconductor examination tool; the method comprising:
obtaining examination output images of the semiconductor specimen acquired by the semiconductor examination tool;
processing the examination output images using a height map generation algorithm dedicated for generating, from each image, a respective height map of the semiconductor specimen, thereby obtaining respective height maps;
modifying at least some of the height maps to include at least one artificially generated three-dimensional (3D) defect, thereby generating respective synthetic fault height maps;
applying a first machine learning model to the respective synthetic fault height maps and to one or more fault-free height maps, wherein the first machine learning model is trained to generate, from height maps of a semiconductor specimen, corresponding synthetic images of the semiconductor specimen, thereby obtaining a group of synthetic fault images and synthetic fault-free images;
generating a training dataset from the group of synthetic fault images and synthetic fault-free images;
utilizing the training dataset for training a second machine learning model dedicated for receiving examination output images of a semiconductor specimen and detecting defects therein.

The present disclosure also contemplates a semiconductor examination system being operatively connected to a semiconductor examination tool; the system comprises at least one processing circuitry configured to execute a defect examination process for detecting defects in a semiconductor specimen according to any one of the fourth aspect and fifth aspect above.

The present disclosure further contemplates a non-transitory program storage device comprising instructions that, when executed by a computer, cause the computer to perform a method according to any one of the fourth aspect and fifth aspect above.

The methods, the systems, and the non-transitory program storage devices, disclosed with reference to the second, third, and fourth aspects, can optionally comprise one or more of features (i) to (ix) listed above, mutatis mutandis, in any technically possible combination or permutation.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1a shows a block diagram schematically illustrating an examination system, in accordance with certain examples of the presently disclosed subject matter;

FIG. 1b illustrates a block diagram schematically illustrating components of a synthetic images generator, in accordance with certain examples of the presently disclosed subject matter;

FIG. 2 is a high-level flowchart showing operations carried out as part of a defects detection process, in accordance with certain examples of the presently disclosed subject matter;

FIG. 3 is a flowchart showing operations carried out as part of an augmented defects detection process, in accordance with certain examples of the presently disclosed subject matter;

FIG. 4a is a flowchart showing operations carried out as part of a synthetic fault images generation process, according to some examples of the presently disclosed subject matter;

FIG. 4b is a flowchart showing operations carried out as part of the generation of an augmented machine learning model involving the synthetic fault images generation process, in accordance with certain examples of the presently disclosed subject matter;

FIG. 5 illustrates a 3D defects implanting process in a height map using Perlin noise, in accordance with certain examples of the presently disclosed subject matter;

FIGS. 6a and 6b show examples of the transformation of a height map to respective SEM output images; and

FIG. 7 is a flowchart showing operations carried out as part of a dynamic defects detection process, in accordance with certain examples of the presently disclosed subject matter.

### DETAILED DESCRIPTION

A wafer is a thin, typically circular slice of semiconductor material, often silicon, that serves as a substrate for manufacturing integrated circuits. A semiconductor die is an independent and discrete component of an integrated circuit, such as an individual computer processor. Each die contains a specific set of electronic components, all fabricated together on the same wafer. Generally, during the fabrication process, multiple dies are created on a single wafer, each being a copy of the same integrated circuit design, effectively yielding identical copies of the integrated circuit.

The process of semiconductor fabrication involves multiple sequential processing steps or layers, each of which can introduce errors that may lead to yield loss. Examples of these steps include lithography, etching, deposition, planarization, growth (such as epitaxial growth), and implantation. Various defect examination operations, such as detection, review, and classification, are performed at different processing steps or layers during the fabrication process to monitor and control quality. These examination operations can be repeated multiple times, for example after certain processing steps or layers.

Machine learning (ML) technologies are sometimes used to assist the detection process to provide more accurate and efficient solutions. However, using ML for defect detection during semiconductor examination presents various challenges.

One challenge in using ML for defect identification in semiconductor imaging is the limited availability of fault examination output images (e.g., output images of Scanning Electron Microscopy) comprising defects, which are needed, among other things, for training the model. In high-quality manufacturing environments, actual defects are rare, resulting in datasets skewed towards non-defective examples. This imbalance undermines the ability of the ML model to effectively recognize and learn from rare defect instances. Furthermore, the diversity in die patterns introduces a wide range of potential defects, adding complexity to the training process, which requires a broad spectrum of data. Rapid technological advancements within the semiconductor industry further complicate this issue by quickly rendering existing training data obsolete.

Human annotation of defects in examination output images also presents several drawbacks. It is a time-consuming process that delays model development and is prone to subjectivity and inconsistency, as different annotators might interpret defects differently, affecting model reliability. Moreover, the manual process does not scale well with increasing data volumes, making it impractical for large datasets. The task requires specialized knowledge, limiting the pool of qualified annotators, and is error-prone, particularly when annotators are fatigued, impacting data quality. Annotators may also miss subtle defects and provide superficial labels, limiting the training data's utility.

Moreover, the challenge is further heightened when dealing with three-dimensional (3D) defects, which require specialized equipment for accurate imaging and data collection. Acquiring high-quality data of real 3D defects is often costly, time-consuming, and labor-intensive, requiring expertise in both domain and data handling. The limited availability of such datasets restricts the ability of researchers and practitioners to train and validate machine learning models effectively.

The scarcity of fault images with defect examples not only affects ML-based approaches, but also poses challenges for traditional, non-ML algorithms. Without a sufficient number of representative defect samples, it becomes difficult to validate and benchmark the performance of these algorithms, hindering their development and optimization.

The presently disclosed subject matter includes a computer system and a computer-implemented method of generating synthetic examination output images (or “synthetic images”), including synthetic fault images and synthetic fault-free images. With respect to the generation of synthetic fault images, the proposed technique involves using a height map generation algorithm for transforming examination output images of a semiconductor specimen into a respective plurality of height maps, incorporating synthetic defects into the height maps and applying a machine learning model to the height maps, dedicated for transforming the height maps into synthetic fault images exhibiting 3D defects (e.g., synthetic fault SEM images).

This approach of generating synthetic fault images offers various advantages over previous approaches. It allows the creation of a balanced training dataset, despite the rarity of actual defects in high-quality manufacturing environments. By artificially generating fault images, this method ensures a sufficient volume of defect examples for training ML models, addressing the issue of skewed datasets. Moreover, synthetic fault images can be designed to include a variety of defect types, across different semiconductor patterns, enhancing the models' ability to recognize and adapt to diverse and complex defect scenarios.

This approach also enables the generation of nominal examination output images (commonly referred to as “No Visible Defects” or NVDs), which helps to enrich the NVDs and improve the classification and segmentation tasks performed using these images. Additionally, it can enhance the variability within the NVDs, allowing for the inclusion of more diverse features, such as different patterns and other characteristics.

As further discussed below, the disclosed technique can be integrated into the semiconductor fabrication process and rapidly adjusted on-the-fly to reflect technological changes and advancements in semiconductor design and manufacturing. This ensures that the training data remains relevant and accurately aligned with the examined specimens. The scalability and adaptability of this approach significantly reduce the reliance on costly and labor-intensive human annotation, streamlining the training process and enhancing the overall efficiency and effectiveness of defect detection systems. Furthermore, unlike conventional methods that typically generate only two-dimensional (2D) defect representations, this technique enables the synthesis of both two-dimensional (2D) and three-dimensional (3D) defects, providing a more comprehensive simulation of real-world defect complexities and interactions. This capability is important, as many defects in semiconductor devices involve depth and volume, which cannot be accurately captured by standard defect synthesis methods.

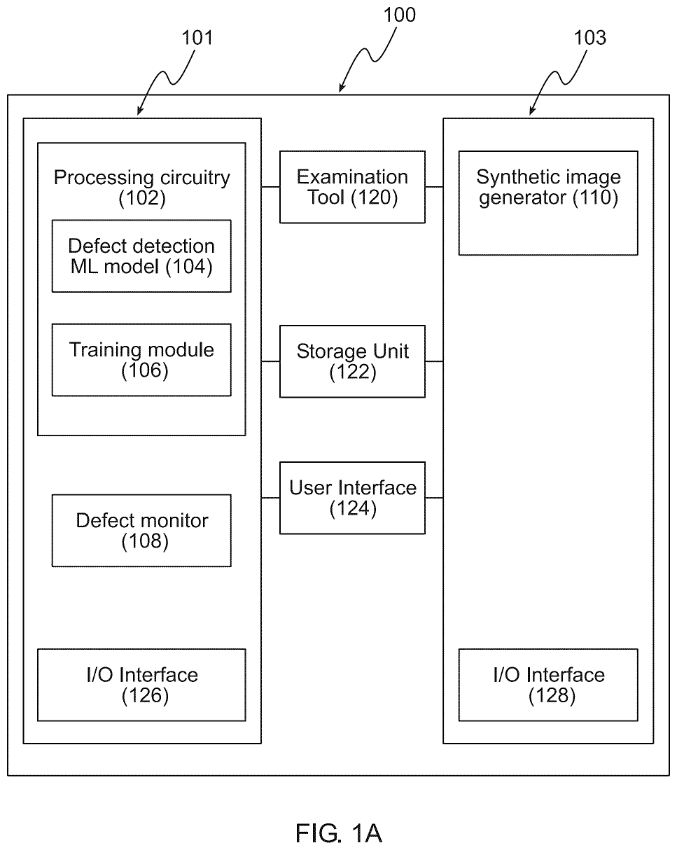

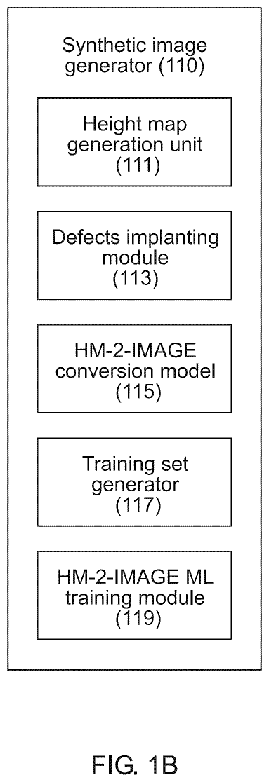

Bearing this in mind, attention is drawn to FIG. 1a showing a block diagram of an examination system in accordance with certain examples of the presently disclosed subject matter. It is noted that while the synthesis of artificial fault images is described below in the context of an examination system, this should not be construed as limiting the scope to this context alone. The methods and techniques discussed can be applied to a variety of other applications and systems where generation of synthetic fault images is relevant.

The examination system 100 illustrated in FIG. 1a can be used for examination of a semiconductor specimen (e.g., a wafer, a die, or parts thereof), for example, as part of the specimen fabrication process. The examination referred to herein can be construed to cover any kind of operations related to defect inspection/detection, defect classification of various types, segmentation, and/or metrology operations with respect to the specimen. System 100 comprises one or more examination tools 120 configured to examine (e.g., scan) a specimen and capture images thereof to be further processed by various examination applications.

The term “examination tool” as used herein should be broadly interpreted to cover any tool used in examination-related processes of a semiconductor specimen, including, but not limited to, scanning, imaging, reviewing, measuring, classifying, and/or other related operations on the specimen or its parts. The examination tools (120) can be implemented as various types of machines. In some examples, the examination tool may be an electron beam machine, such as a Scanning Electron Microscope (SEM) or a Transmission Electron Microscope (TEM), an Atomic Force Microscope (AFM), X-ray microscopy, or other similar tools. It should be noted that the presently disclosed subject matter can work with examination output images from different types of examination tools and is not limited to any specific tool. Any reference to a particular type of examination tool (predominantly SEM) in the following description is provided by way of non-limiting example only. Images generated by an examination tool are also referred to herein as “examination output images”.

Considering an SEM, it is a type of electron microscope that produces grayscale images of a specimen by scanning it with a focused beam of electrons. The operation of an SEM involves directing a focused beam of high-energy electrons toward a sample surface. This electron beam is generated by an electron gun and then precisely focused and directed using electromagnetic lenses. As the electron beam scans across the surface of the sample, it interacts with the atoms, leading to various outcomes such as the emission of secondary electrons, backscattered electrons, and characteristic X-rays.

The detection of secondary electrons (emitted from atoms near the surface) allows for high-resolution imaging of the sample's topography. Backscattered electrons, which are the primary electrons electromagnetically deviated from the sample atoms, provide information on the composition and contrast based on atomic number differences within the sample.

Detectors designed for specific types of emissions capture the signals resulting from these interactions. This collected data is then processed to produce a grayscale image, indicating the quantity of electrons captured by the detector. The number of collected electrons varies, depending on the surface topography, composition, or other properties of the sample. Through this process, SEMs can generate highly detailed grayscale images of the sample surface at magnification levels unattainable with traditional optical microscopes, providing precise inspection and measurement capabilities during the manufacturing of semiconductor wafers.

Examination tools 120 may include both inspection and review tools. Inspection tools (e.g., SEM), capture images of the specimen (e.g., by scanning), which are then analyzed by defect detection algorithms to identify potential defects. The results are typically presented as a defect map, showing the distribution of defect candidates across the semiconductor specimen. Review tools (also including SEM) are configured for detailed examination of specific areas where defects have been identified, allowing for close-up, high-resolution analysis of these targeted sections of the specimen.

According to certain examples of the presently disclosed subject matter, the examination system 100 comprises a computer-based semiconductor analysis system 101 operatively connected to the examination tools 120. System 101 includes a processing circuitry 102 operatively connected to a hardware-based I/O interface 126 and configured to provide processing necessary for operating the system, as further detailed with reference to the figures described below.

Processing circuitry 102 can comprise one or more processors and one or more memories (not shown separately). The one or more processors of the processing circuitry 102 can be configured to, either separately or in any appropriate combination, execute several functional modules in accordance with computer-readable instructions implemented, for example, on a non-transitory computer-readable memory comprised in the processing circuitry. Such functional modules are referred to hereinafter as comprised in the processing circuitry.

In some examples, one or more functional modules within the processing circuitry 102 can include a machine learning (ML) model 104 dedicated to processing examination output images for detecting defects (also referred to as a “defect detection ML model”). Upon obtaining a plurality of images of a semiconductor specimen acquired by an examination tool (e.g., the examination tool 120), ML model 104 processes these images for defect detection and generates a set of images labeled with detected defects.

System 101 can also be configured as a training system capable of training a ML model during a training/setup phase. To this end, system 101 includes a training module 106 dedicated to training ML model 104. Once trained, ML model 104 can be used for runtime defect examination. In some examples, system 101 can train a ML model in runtime and make it available for execution immediately after training. ML model 104 can be trained in runtime using images of semiconductor specimens acquired during the fabrication process. This allows the model to adapt to variations in semiconductor design and perform on-the-fly defect detection.

It should be noted that in some examples, defect detection ML model 104 refers to a trained ML model previously trained (e.g., by the training module 106) using a training set comprising a subset of synthetic fault images (also referred to as “synthetic fault examination output images”) and a subset of nominal images (NVDs).

According to some examples, examination system 100 includes a synthetic image generator 110 configured to generate the collection of synthetic fault images, which can be used for training/re-training the defect detection ML model 104. In some examples synthetic image generator 110 is implemented as a dedicated processing circuitry within a separate computer system or device 103 operatively connected to examination tool 120, storage unit 122, and system 101. In other examples, synthetic image generator 110 can be implemented in a separate processing circuitry within system 101. In yet another example, synthetic image generator 110 can be implemented as part of processing circuitry 102. Processing circuitry of synthetic image generator 110 can comprise one or more processors (not shown separately) and one or more memories (not shown separately) which are configured, either separately or in any appropriate combination, to execute functional modules in accordance with computer-readable instructions implemented on a non-transitory computer-readable memory comprised in the processing circuitry.

FIG. 1b is a block diagram schematically illustrating a more detailed view of various components of synthetic image generator 110, which are shown by way of non-limiting example only. These components include, in some examples, height map generation module 111 configured to apply an algorithm for generating height maps (or “3D maps”) from examination of output images; defects implanting module 113 configured to implant synthetic 3D defects in the generated height maps, height map (HM)-2-IMAGE conversion ML model 115 trained and usable for generating synthetic fault (SEM) images based on the height maps, training set generator 117 configured to generate a training set for training defect detection ML model 104, and HM-2-IMAGE ML training module 119 configured to train the HM-2-IMAGE conversion ML model. Operation of system 100, particularly of processing circuitries 102 and 110, and the functional modules therein, are detailed below with reference to the figures below.

Machine learning models described herein (including, defect detection ML model 104 and HM-2-IMAGE conversion model 115) can be implemented using various types of ML models, and are not limited to a specific model type or learning algorithm. In some examples, defect detection ML model 104 and HM-2-IMAGE conversion model 115 may be implemented as a deep neural network (DNN). By way of non-limiting example, the layers of the DNN can be organized following architectures such as Convolutional Neural Networks (CNN), Recurrent Neural Networks (RNN), Recursive Neural Networks, Generative Adversarial Networks (GAN), Variational Autoencoders, Diffusion models, Transformers, or other configurations. Optionally, some of the layers may be structured into multiple DNN sub-networks. Each layer of the DNN may consist of numerous basic computational elements (CE), commonly referred to as dimensions, neurons, or nodes.

The deep neural network can be pretrained prior to training and can be further iteratively adjusted or modified during training to achieve an optimal HM-2-IMAGE conversion. After each iteration, a loss function is computed to measure the quality of the HM-2-IMAGE conversion produced by the DNN module. Training can be determined to be complete when the loss function is less than a predetermined value, when a limited change in performance between iterations is achieved, or when the number of iterations reaches the allowed maximum. A set of input data used to adjust the parameters of a deep neural network is referred to as a training set.

While the teachings of the presently disclosed subject matter are not bound by specific architecture of the ML model or DNN as described above, one example of DNN architecture that can be used for ML model 104 and/or ML model 115 is a U-Net architecture. This type of model can be regarded as being composed of two main functionalities/parts: an encoder, and a decoder. The encoder performs feature extraction by encoding the input image into features of various semantic levels. The decoder decodes these features into a segmentation map. The encoder and decoder usually include convolutional layers, fully connected layers, activation functions, normalization layers, and/or pooling layers.

According to some examples, system 100 comprises a storage unit 122, comprising one or more types of computer memory. The storage unit can be shared by processing circuitry 102 and synthetic images generator 110. In other examples, e.g., where processing circuitry 102 and synthetic images generator 110 are configured as separate entities, each may be operatively connected to a dedicated storage unit. The storage unit 122 is configured to store any data necessary for the operation of system 101, such as data related to the input and output of the system, as well as intermediate processing results generated by system 101. For example, storage unit 122 may store runtime images, height maps, examination output images produced by the examination tool 120, and/or their derivatives. In some examples storage unit 122 can be used for storing data related to and generated by synthetic image generator 110, such as height maps and synthetic fault images generated by the synthetic image generator 110. The synthetic fault images stored can then be made available to processing circuitry 102 for further processing.

According to some examples, system 100 and/or 101 comprises a user interface 124, to enable user interaction with system 100. The user interface can be shared by processing circuitry 102 and synthetic images generator 110. In other examples, e.g., where processing circuitry 102 and synthetic images generator 110 are configured as separate entities, each may be operatively connected to a dedicated user interface. The user interface can include a display device, user interaction devices (e.g., computer mouse and keyboard) and a graphical user interface (GUI) configured to enable, inter alia, user-specified inputs related to system 100. For instance, the user may be provided, through the GUI, with options of defining certain operations and/or parameters (e.g. ML parameters). The user may also view on the display device the processing results or intermediate processing results, such as, e.g., the height maps, synthetic fault images, NVD images, detected defects, etc.

Computer systems 101 and 103 can further comprise one or more I/O interfaces (126, 128) dedicated for transmitting and receiving data with other entities. I/O interfaces can be used for example for data communication with examination tool 120 and between system 101 and 103. In some cases, I/O interface is used for communicating processing output to the storage unit 122, and/or external systems e.g., Yield Management System of a fabrication plant (fab). A Yield Management System in semiconductor manufacturing is a data management and analysis tool that collects and analyzes production data, especially during ramp-ups, to help engineers improve yield. It allows semiconductor manufacturers to manage large volumes of production analysis with fewer engineers by generating reports based on yield data. YMS is utilized by Integrated Device Manufacturers (IDMs), fabs, fabless semiconductor companies, and Outsourced Semiconductor Assembly and Test (OSAT) providers.

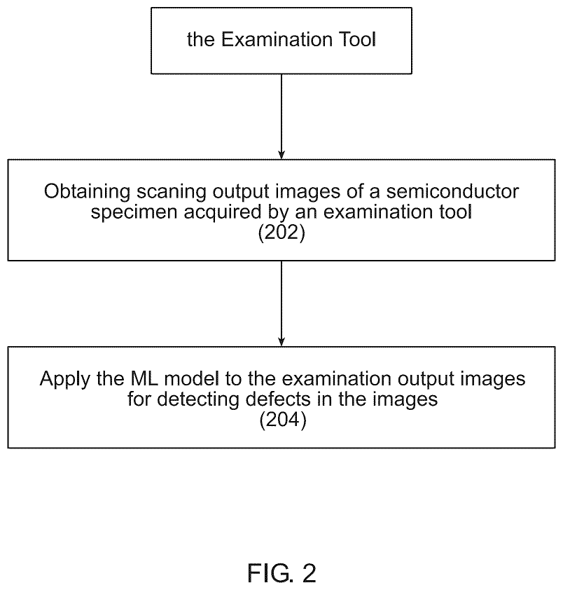

Turning to FIG. 2, it shows a high-level flowchart of operations carried out as part of a defects detection process, according to examples of the presently disclosed subject matter. It is noted that while operations in FIG. 2, as well as in other figures, are described with reference to various components in FIGS. 1a and 1b, this is done by way of example only and should not be construed as limiting the processes to the specific design illustrated in any of these figures.

A plurality of images of a semiconductor specimen acquired by an examination tool can be obtained (202) (e.g., by processing circuitry 102 from the examination tool 120). As mentioned above, such images are also referred to herein as “examination output images”. A semiconductor specimen here can refer, for example, to a semiconductor wafer, a die, or parts thereof, that is fabricated and examined in the fab during a fabrication process thereof. An image of a specimen can refer to an image capturing at least part of the specimen. By way of example, an image can capture a given region or a given structure (e.g., a structural feature or pattern on a semiconductor specimen) that is of interest to be examined on a semiconductor specimen. For instance, the image can be an image acquired in runtime during in-line examination of the semiconductor specimen. It is to be noted that the plurality of examination output images refers to real images of the specimen that are acquired by the tool, contrary to synthetic images, which are artificially generated, as will be described below.

The fabrication process of a specimen typically comprises multiple processing steps. In some cases, a sampled set of processing steps can be selected therefrom for in-line examination, based on their known impacts on device characteristics or yield. Images of the specimen or parts thereof can be acquired at the sampled set of processing steps to be examined. It is noted that the description set forth herein is applicable to any suitable processing step of a specimen, without limitation.

According to a non-limiting example, the plurality of examination output images can be processed using the defect detection ML model 104 for defect detection (204), thereby obtaining, from the plurality of examination output images, a set of images labeled with detected defects. The detected defects referred to herein can refer to any type of defective features on a specimen such as, e.g., a scratch, bump, surface roughness, bridge, particle, line-cut, protrusion, intrusion, missing pattern, etc. In some cases, the defects can also include variations related to any pattern, structure, or image, such as, e.g., bent lines, edge roughness, surface roughness, CD variation/shift, gray level variation, etc. It is to be noted that the variations referred to herein should not be limited to any specific size or resolution. A defect or “variation” in the semiconductor generally means that one or more characteristics of a design formed on the specimen are outside of a desired range of values for those one or more characteristics.

As explained above, the limited availability of fault images creates various challenges in the examination of semiconductors, including challenges related to the use of a ML model for defect detection. One of these challenges is related to difficulty in creating a training set that includes examination output images exhibiting topographic (i.e., 3D) defects, such as bumps, holes, craters, or scratches.

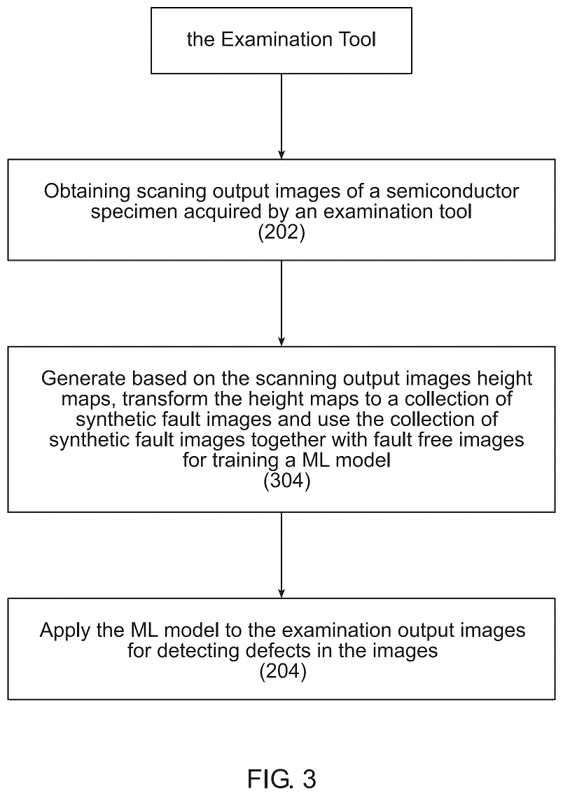

FIG. 3 is a high-level flowchart showing operations carried out as part of an augmented defects detection process, in accordance with certain examples of the presently disclosed subject matter. The term augmented in this context refers to the fact that an improved ML model for detection of 3D defects is generated.

FIG. 3 shows an alternative approach to FIG. 2, where examination output images of the semiconductor specimen generated by the examination tool are used for generating respective height maps. The height maps, after being implanted with 3D defects, are converted back to respective synthetic fault images. Once a sufficiently large collection of synthetic fault images suitable for training a ML model is available, it is used alongside nominal (NVD) images to create a training set for training an augmented ML model specifically designed to detect specific types of defects (304).

The training set can be stored, for example, in storage unit 122, and made available to training module 106 that is configured to use the stored data for training an augmented defect detection ML model (104). The generation of synthetic fault images is based on images (e.g., NVDs) obtained from the examination tool, and is modified to simulate various types of defects. This approach allows for the creation of a training set exhibiting diverse 3D defects, without the need for examination of output images that capture true defects of the desired types. Using the height maps also eliminates the need to use design data, such as computer-aided design (CAD) files of the semiconductor specimen, which are often unavailable as they contain valuable Intellectual Property and proprietary information and are kept secret by semiconductor manufacturers.

Once available, the augmented ML model can be applied on examination output images received from the examination tool for detecting defects in the images (204).

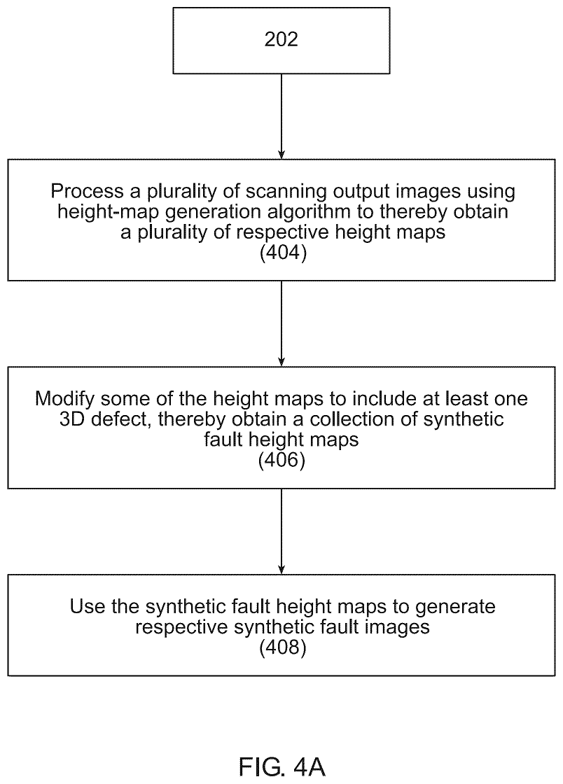

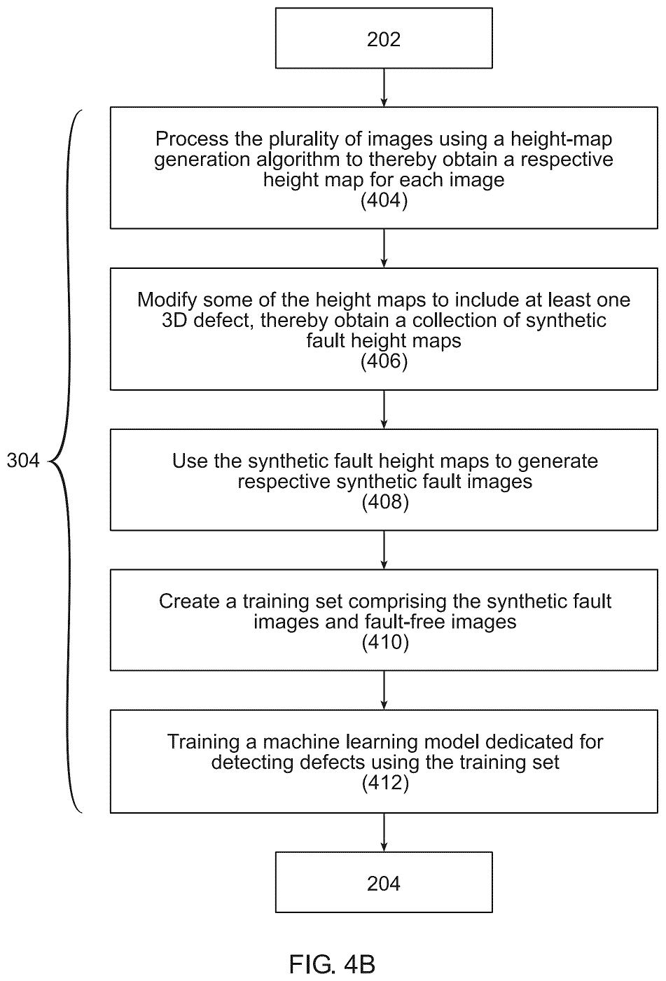

Turning to FIG. 4a, it is a flowchart depicting the operations involved in the generation of synthetic fault images, according to certain examples of the presently disclosed subject matter. FIG. 4b is a flowchart illustrating the operations involved in the development of an augmented machine learning model that is trained using synthetic fault images generated according to the process described in FIG. 4a. By way of example, operations in FIG. 4a are described primarily with respect to the synthetic image generator 110.

For ease of understanding, the operations in FIG. 4a are described in the context of FIG. 4b. However, this should not be construed as limiting the application of synthetic fault image generation to this purpose alone. In addition to their role in augmenting training datasets for machine learning models, synthetic fault images serve multiple crucial functions in semiconductor testing. For example, they can be used for benchmarking various testing methods and tools by creating standardized test sets with known faults, allowing precise performance comparisons and evaluations. Synthetic fault images also facilitate the development and validation of new fault detection algorithms, help in stress testing to ensure system robustness under different conditions, and assist in process optimization by identifying specific areas needing improvement.

As explained above, examination output images generated by the examination tool (120) are obtained (202). For example, as part of a semiconductor specimen fabrication process, a specimen can be scanned by a SEM examination tool and the SEM output images are transmitted to synthetic image generator 110.

A height map generation algorithm is applied for transforming the examination output images to respective height maps (404; e.g. by height map generation algorithm module 111). Height maps are detailed depictions of the surface topography of semiconductor materials, capturing variations in height (or depth) to provide a 3D profile of surface features.

A key principle of the height map generation algorithm is the Lambert reflection law, which describes the angular distribution of secondary electrons emitted from a sample surface under electron beam irradiation. The intensity of these emitted electrons follows a cosine relationship with the angle between the surface normal and the detector's viewing direction.

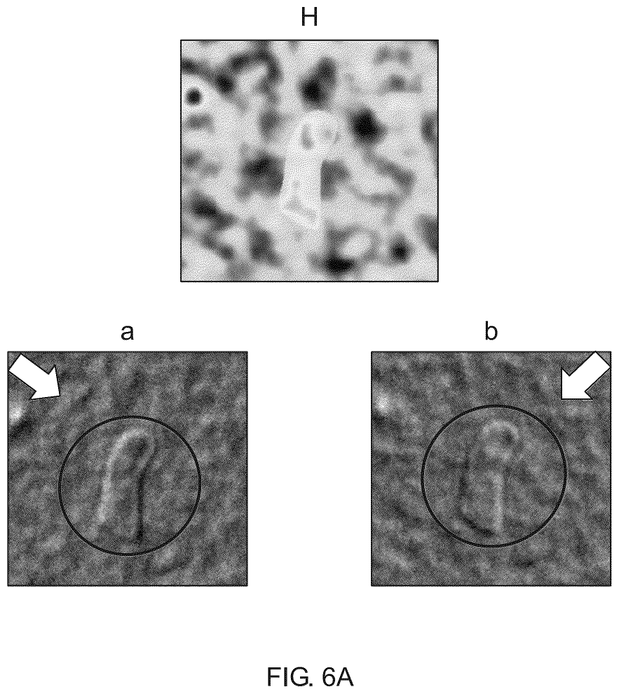

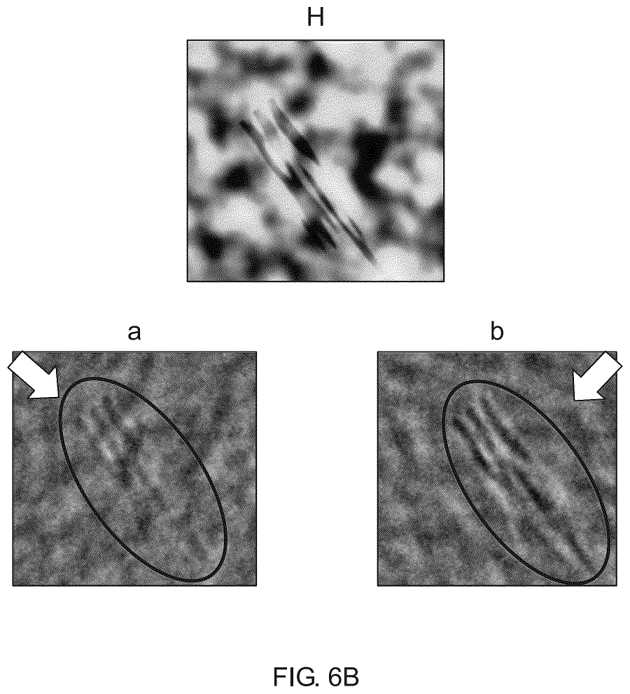

When the sample surface is flat, detectors surrounding the sample receive an equal intensity of emitted electrons, as the reflection is symmetric around the surface normal. However, if the surface exhibits topographic variations, the intensity of electrons received by each detector will vary, based on the local slope or tilt of the surface relative to the detector's viewing angle. This variation in intensity of electrons is demonstrated in FIGS. 6a and 6b referred to below. A height map can be generated using multiple respective SEM images, each corresponding to a particular perspective of the SEM.

By analyzing the relative electron intensities captured by multiple detectors positioned around the sample at different viewing angles, the 3D topography or height map of the sample surface can be reconstructed. This reconstruction accounts for both lateral (azimuthal) and altitude (elevation) angle variations, as the Lambert cosine law applies to the full 3D surface normal.

Examples of a height map generation algorithm that can be used for transforming examination output images such as SEM images into height maps by a height map generation algorithm leveraging the Lambert reflection principle include:

Stereoscopic Imaging: This model involves tilting the electron beam or sample to capture two or more SEM images from different viewing angles. The relative shifts in feature positions between these images provide depth information, enabling height map reconstruction.

Time-of-Flight: This model measures the round-trip time for the electron beam to reach the sample surface and the reflected electrons to return to the detector. This time-of-flight information is used to calculate the distance to each point on the surface, generating a height map.

Shape-from-Shading: This model applies Lambert reflection principles to analyze shading patterns in SEM images. The intensity variations are related to surface gradients, which can be integrated to recover the height map.

These height map generation algorithms, along with potential combinations or variations, can be utilized to convert acquired SEM images into height maps, allowing for high-resolution characterization of surface topography. The result of applying these height map generation algorithms to the examination output images is a collection of detailed height maps.

The collection of height maps is subjected to processing steps dedicated for implanting defects in the height maps (406; e.g., by defects implanting module 113). The modifications applied to each height map include changing the topography of the height map to represent at least one 3D defect to thereby obtain respective “synthetic fault height maps” i.e. height maps with at least one artificially generated 3D defect.

Implanting defects can be performed by applying various modification functions on the height maps. This includes, for example, inserting one or more Gaussian shapes to the height map for the implanting of a bump, or inserting an inversed Gaussian shape for implanting a crater. As is well known in the art, a 2D Gaussian shape is defined by a 2D Gaussian formula that includes parameters such mean, standard deviations, and amplitude. These parameters determine the final Gaussian shape. By adjusting these parameters in the 2D Gaussian formula, a desired bump or crater shape can be achieved.

Another example is a scratch that can be defined by parameters such as length, width, depth, orientation position, profile (e.g., rectangular, round, triangular, etc.), and smoothness.

According to some examples, a range of values of each parameter are provided (e.g., retrieved from data storage 122) and an actual value is selected from these ranges and used for creating the shape (e.g., Gaussian or scratch). The selection can be done, for example, automatically (e.g., by randomly selecting a value within each prescribed range), or by a user. Once the shape has been determined, a corresponding defect characterized by this shape is implanted in the height map. For changing the height map, the pixel heights at the planting location are modified, as prescribed by the shape of the 3D defect. In some cases, placement of the defects in the map is done by first defining various areas of exclusion, where defects should not be added, (e.g., near the edges of the height map), and then selecting (e.g., randomly) a planting location within the map.

According to some examples, procedural generation commonly used in computer graphics, such as Perlin noise and Voronoi noise, are used to create 3D defects characterized by random textures and/or complex geometry. Perlin noise is a method that leverages smooth, gradient-based randomness to simulate natural variations and intricate surface details. By adjusting parameters such as scale, frequency, and amplitude, Perlin noise can generate realistic 3D defect patterns.

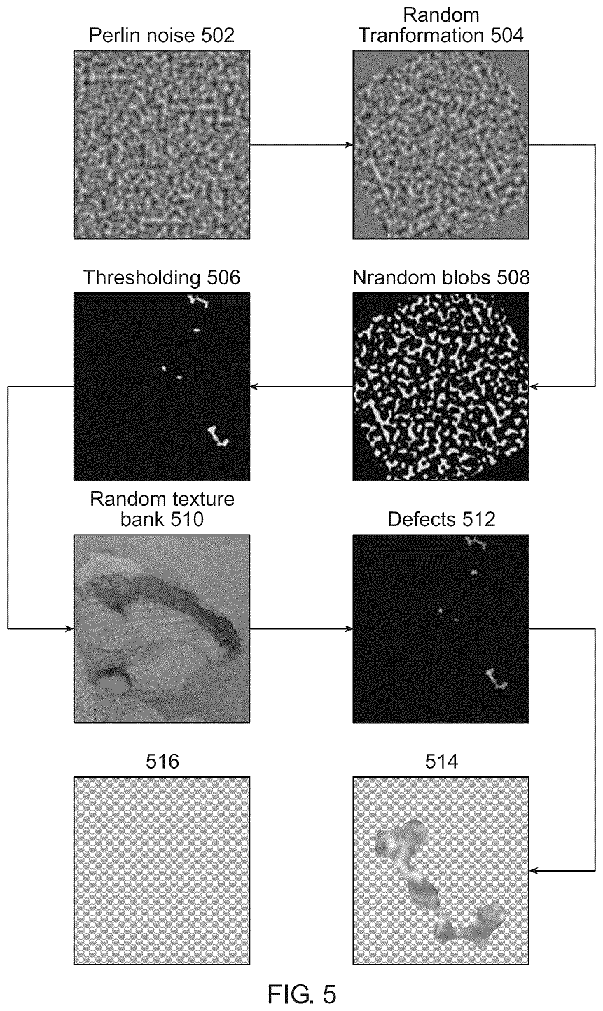

FIG. 5 illustrates an example of 3D defects implanting in a height map using Perlin noise. In the first step, Perlin noise is generated (502). The process of adding 3D features to the height map by applying Perlin noise involves defining the Perlin noise with two key aspects:

Seed Value: This value defines the starting point for randomness within the Perlin noise function. Using the same seed value will always produce the same noise pattern, ensuring reproducibility.

Perlin Noise Parameters: These parameters, such as scale, octaves, persistence, and lacunarity, influence the characteristics of the noise, based on the seed's randomness. They define properties like the level of detail, roughness, and distribution of features within the generated noise.

The Perlin noise function uses the seed value and the parameters to calculate and combine multiple octaves of noise to create the final result. Each octave has a different frequency and amplitude. The base octave has the largest features and the highest influence, while higher octaves add finer details. Combining these octaves produces a complex and realistic 3D surface that captures natural-looking variations and intricate details. The generated noise values can be mapped onto the height map grid at the planting location to determine updated elevations.

After generating the initial Perlin noise (and before mapping it to the height map), various mathematical transformations can be applied to achieve desired effects and create more intricate 3D features (504). These transformations may involve scaling the noise values to adjust feature size, shifting them to control positioning within the map, or even combining them with other Perlin noise functions for increased complexity. For instance, a sinusoidal transformation can be employed to introduce periodic variations, resulting in features that repeat with a specific frequency.

In some examples, thresholding is applied on the Perlin noise (506). This includes setting a threshold value and modifying the noise map such that values above the threshold are set to one value (e.g., high), and values below the threshold are set to another value (e.g., low). This can be used to create distinct features like cliffs or plateaus.

Features (defects) can be added to the height map by the addition of N (where N≥1) blobs to the height map, each blob corresponding to a 3D defect (508). N represents the number of individual 3D defects which are added to the height map.

In some examples, a texture can be selected (e.g., randomly) from a database comprising various textures (e.g., texture bank) and blended with the Perlin noise (510). The blending of the smooth, natural variations of Perlin noise with the more detailed and complex patterns from the texture bank allows for the creation of a more realistic and intricate 3D feature in the height map.

Finally, the N 3D defects are planted in the height map to create the modified (augmented) height map (514) which is shown in comparison to the original, defect-free wafer (516).

Notably, in some examples the entire process of generating 3D defects can be completely automatic, where, as mentioned above, the relevant type of 3D defects and their corresponding parameters are either predefined or selected in real-time (e.g., randomly or according to some predefined logic). In other examples, some human intervention may be required, e.g., for selecting the types of defects and/or their respective parameters. Optionally, in addition to 3D defects, 2D defects can also be added to the height map to enable the simulation of a mix of 3D and 2D defects in the final synthetic fault images.

Reverting to FIG. 4b, once the synthetic fault height maps have been generated, they are used for generating corresponding synthetic fault images (408). According to some examples, generation of the synthetic fault images is performed using a dedicated ML model (HM-2-IMAGE conversion ML model 115). This model is trained to receive height maps (e.g., synthetic fault height maps) as input, and generate corresponding examination output images (e.g., SEM output images). The resulting output of the ML model is a collection of synthetic fault images, that simulate examination output images of a semiconductor specimen with 3D (and possibly 2D) defects, as would have been generated by an examination tool. According to one example, when the examination output images initially received from the examination tool are SEM images, HM-2-IMAGE conversion ML model 115 is configured to generate synthetic fault SEM images.

As mentioned above, in a similar way, the system can also generate synthetic NVDs (synthetic fault-free images). These artificially generated NVDs are different from NVDs generated by the examination tool (“real-NVDs”) when scanning a defect-free specimen. Synthetic NVDs are generated by applying a similar operation flow to the one described above with reference to block 304, albeit without incorporating defects. This process includes transforming real NVDs into respective height maps, and then transforming the height maps into synthetic NVDs by applying the NVD height maps to the HM-2-IMAGE conversion ML model 115.

HM-2-IMAGE ML training module 119 is configured to train the HM-2-IMAGE conversion ML model 115. In some non-limiting examples, the HM-2-IMAGE conversion ML model is trained as a Pix2Pix model, which is a type of Generative Adversarial Network (GAN) specifically designed for image-to-image translation tasks, where the goal is to transform an input image into one or more corresponding output images. By way of example, the HM-2-IMAGE conversion ML model 115 can be pre-trained using a set of training samples, each comprising a height map and corresponding actual examination output images (e.g., SEM), each from a different perspective. The model can be trained to learn to map between the two image representations, a height map and the corresponding examination output images. Upon being trained, given the input of the height maps with implanted defects, the model can output synthetic fault images corresponding thereto. According to one non-limiting example, the height map can be represented as a grid where each point is assigned a value between 0 and 1, with this normalized value indicating the relative height at that specific location. During machine learning training, this normalized format allows the model to consistently interpret the height information across the entire input, enabling it to learn how variations in these values correspond to features in the generated images.

FIG. 6a shows an example of transformation of height map H comprising a blob to respective synthetic fault SEM images showing the blob. As demonstrated in FIGS. 6a and 6b, for each height map more than one respective SEM image can be generated, each for a certain perspective, including top view and different side views. FIG. 6a shows, at the top, the synthetic fault height map and two perspectives of the corresponding synthetic fault SEM image where the topographic defect can be seen. Each of the two images, a and b, simulates the electron reflections received by a specific detector when scanning the specimen. As these detectors are positioned at different corners, each detector captures reflections from a unique angle. The images illustrate how the electron reflections vary, based on the detector's position and orientation, providing a comprehensive view of the specimen's surface topography and particularly the blob. FIG. 6b shows another example featuring 3D defects created using Perlin noise, specifically demonstrating the appearance of Perlin scratches.

In some examples, such as when used for the purpose of training a ML learning model, once the synthetic fault images have been generated, they are mixed with fault-free images to create an updated training set for the defect detection ML model (410; e.g., by training set generator 117). The updated training set can be stored, for example, in storage unit 122 and made available to training module 106, which uses the training set for generating an augmented defect detection model 104. Notably, the training set can also include samples of other examination output images that include other types of defects. For example, training can also include real fault images with real defects (e.g., real fault images used to train previous models). This approach enables to obtain a comprehensive model capable of detecting various types of defects in one step.

In some examples, the augmented defect detection model 104 can be an updated (retrained) version of the previous defect detection ML model, where new defects are introduced to expand the defect detection ability of the existing model, while in other examples the augmented defect detection model 104 is a new ML model that replaces a previous defect detection model.

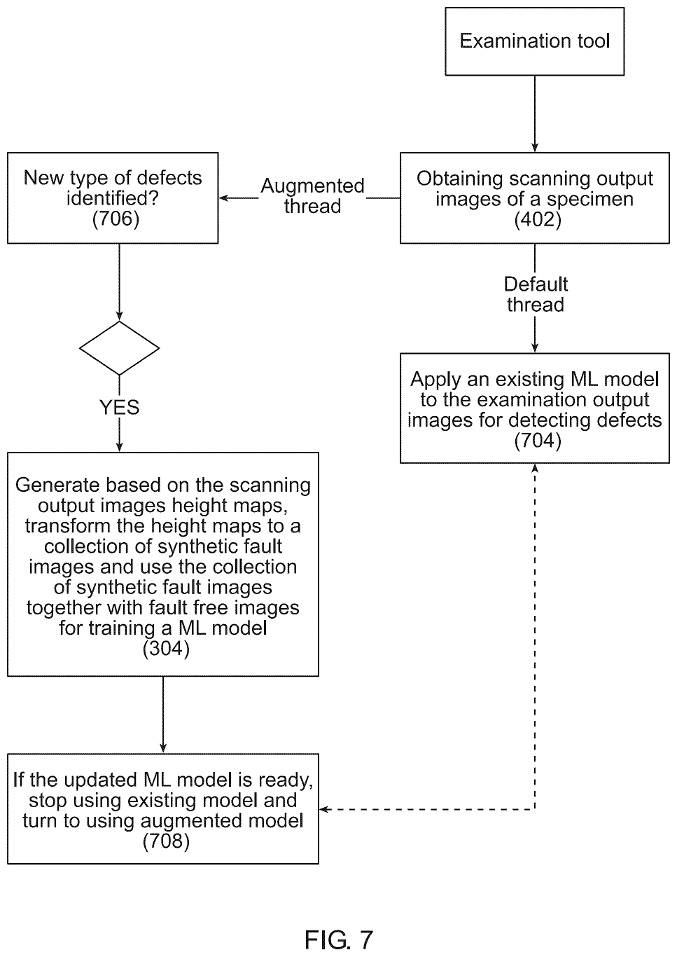

FIG. 7 is a flowchart showing an example of a defect detection process that includes dynamic update of the defect detection ML model. According to this approach examination output images are initially processed using an existing (or default) defect detection ML model (default thread 704). At the same time examination output images are examined, and if the examination output data reveals a new type of defect that was not included in the training set, and thus the existing model was not trained to detect these defects (706), a dynamic model augmenting procedure is initiated. This procedure is dedicated for training an augmented ML model capable of detecting the new type of defect, as described above with reference to FIG. 4b (304). Once the augmented model is ready, it replaces the default ML model and is used in its stead for defect detection (708).

The synthetic defects that are added to the height maps to create the fault height maps as disclosed above represent the new type of defects found in the examination output images. A new type of 3D defect can be detected automatically or by a human reviewer. System 101 can respond to such a notification of a new defect type by initiating a process of generating an augmented defect detection ML model that is trained to identify the new type of defect. For example, system 101 can comprise a defect monitor 108 configured to identify new types of defects in examination output images or receive user input from a user indicating that a new type of defect has been identified characterizing the defect, to enable implanting of a respective 3D in the height map to ultimately update the defect detection ML model to identify this new type of defect, as explained above.

The synthetic fault images generated as described above effectively augment the training set used for training the defect detection model 104 with new examples of 3D defects and addresses the issue of lack of defective images needed for training the model, as well as the need to reduce the annotation efforts. By applying this process in real-time as part of the semiconductor examination process, possibly as part of the semiconductor fabrication flow, the system can automatically adapt, on-the-fly, for detecting new types of defects previously not disclosed in the training set, and thus improve its detection efficiency and accuracy.

In addition to dynamic update of existing machine learning models, synthetic fault images can also be used for creating a training set of a machine learning model, based on one or more predefined defects of interest provided, for example before the examination process. For a given semiconductor design, if it is desired to examine a particular type of 3D defect in the fabricated specimens, information on this defect can be provided to system 103. Based on this information, the generation of the relevant synthetic fault images that exhibit these defects can be initiated. These images are subsequently used to train a defect detection ML model capable of detecting these defects. These defects are integrated into a height map to create respective synthetic fault images that comprise these defects, to ensure the existence of a comprehensive variety of defects and use the defects in training a respective defect detection ML model.

Those versed in the art will readily appreciate that the teachings of the presently disclosed subject matter are not bound by the system illustrated in FIGS. 1a and 1b. Each system component and module in FIGS. 1a and 1b can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIGS. 1a and 1b.

Each component in FIGS. 1a and 1b may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

While certain examples of the present disclosure refer to a processing circuitry being configured to perform the above recited operations, the functionalities/operations of the aforementioned functional modules can be performed by the one or more processors in the processing circuitry in various ways. By way of example, the operations of each module can be performed by a specific processor, or by a combination of processors. The operations of the various functional modules, such as processing the examination/inspection image, and performing defect examination, etc., can thus be performed by respective processors (or processor combinations), while, optionally, these operations may be performed by the same processor. The present disclosure should not be limited to being construed as one single processor always performing all the operations. Furthermore, any reference made in the specification and claims to a single processing circuitry should be interpreted to optionally include multiple processing circuitries.

The systems illustrated in FIGS. 1a and 1b can be implemented in a distributed computing environment, in which one or more of the aforementioned components and functional modules shown in FIGS. 1a and 1b can be distributed over several local and/or remote devices. By way of example, the examination tool 120 and systems 101 and/or 103 can be located at the same entity (in some cases hosted by the same device), or distributed over different entities, each located at a different location.

In some examples, certain components utilize a cloud implementation, e.g., are implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

Unless specifically stated otherwise, as apparent from the above discussions, it is appreciated that, throughout the specification, discussions utilizing terms such as “obtaining”, “generating”, “applying”, “executing”, “utilizing”, “modifying” or the like, include an action and/or processes of a computer that manipulate and/or transform data into other data, said data represented as physical quantities, e.g. such as electronic quantities, and/or said data representing the physical objects.

The terms “computer”, “computer system”, “computer device”, “computerized device”, “computerized system” or the like, used herein, should be expansively construed to include any kind of hardware-based electronic device with one or more data processing circuitries. Each processing circuitry can comprise, for example, one or more processors operatively connected to computer memory, capable of executing stored instructions to perform the operations described herein. Any reference made in the description or claims to a processing circuitry should be construed to include also multiple processing circuitries.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices, such as an application specific integrated circuit (ASIC), a field programmable gate array (FPGA), a digital signal processor (DSP), a graphics processing unit (GPU), a network processor, or the like.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately, or in any suitable sub-combination.

In various examples of the presently disclosed subject matter, fewer, more and/or different stages than those shown in FIGS. 2, 3, 4a, 4b, and 7 may be executed. In some examples one or more stages illustrated in the figures may be executed in a different order, and/or one or more groups of stages may be executed simultaneously.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable (e.g., non-transitory) memory tangibly embodying a program of instructions executable by the machine for executing the method of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A computer system configured for automatic generation of synthetic images of a semiconductor examination tool, the system comprising a processing circuitry configured to:
obtain one or more images of a semiconductor specimen acquired by the semiconductor examination tool;
process the one or more images using a height map generation algorithm dedicated to generating, from each image, a respective height map of the semiconductor specimen, thereby obtaining one or more height maps;
modify at least some of the one or more height maps to include at least one artificially generated three-dimensional (3D) defect, thereby generating one or more respective synthetic fault height maps;
apply a first machine learning model to the one or more respective synthetic fault height maps, wherein the first machine learning model is trained to generate, from a height map of a semiconductor specimen, a corresponding synthetic image of the semiconductor specimen, thereby obtaining one or more respective synthetic fault images.

2. The system of claim 1, wherein the one or more examination output images include one or more fault-free images; and wherein the processing circuitry is configured to:
process the one or more fault-free images using a height map generation algorithm dedicated for generating, from each image, a respective height map of the semiconductor specimen, thereby obtaining one or more height maps;
apply the first machine learning model to the one or more height maps, thereby obtaining one or more respective synthetic fault-free images.

3. The system of claim 1, wherein generation of synthetic fault images is executed as part of a defects detection process, dedicated for detecting defects in examination output images of a semiconductor specimen; wherein the processing circuitry is configured to execute, as part of the defects detection process:
generate a training dataset from the synthetic fault images;
utilize the training dataset for training a second machine learning model dedicated for receiving examination output images of a semiconductor specimen and detecting defects therein.

4. The system of claim 2, wherein generation of synthetic fault images and synthetic fault-free images is executed as part of a defects detection process, dedicated for detecting defects in examination output images of a semiconductor specimen; wherein the processing circuitry is configured to execute, as part of the defects detection process:
generate a training dataset from the synthetic fault images and fault-free images;
utilize the training dataset for training a second machine learning model dedicated for receiving examination output images of a semiconductor specimen and detecting defects therein.

5. The system of claim 4 wherein the processing circuitry is configured, following training of the second machine learning model, to apply the second machine learning model to other examination output images of the semiconductor specimen acquired by the semiconductor examination tool, thereby detecting defects in the semiconductor specimens.

6. The system of claim 5, wherein the defects detection process is executed as part of a semiconductor examination process for detecting defects in real-time during fabrication.

7. The system according to claim 5, wherein the processing circuitry is configured to initiate execution of the defects detection process responsive to receiving data indicating that examination output images of a semiconductor specimen contain a type of defect that was not included in a training set used for training the second machine learning model, wherein the at least one artificially generated three-dimensional (3D) defect includes the type of defect, thereby updating the second machine learning model to detect the type of defect, on-the-fly.

8. The system of claim 1, wherein the processing circuitry is configured for modifying each height map to include at least one artificially generated 3D defect to apply procedural generation methods for creating a 3D defect and implanting the 3D defect in the height maps.

9. The system of claim 8, wherein the procedural generation methods include at least one of Perlin noise and Voronoi noise.

10. The system of claim 1 wherein the semiconductor examination tool is a Scanning Electron Microscope (SEM), and the examination output images are SEM images of the semiconductor specimen.

11. A computer-implemented method of generating synthetic images of a semiconductor examination tool, comprising:
obtaining one or more examination output images of a semiconductor specimen acquired by the semiconductor examination tool;
processing the one or more examination output images using a height map generation algorithm dedicated for generating, from each image, a respective height map of the semiconductor specimen, thereby obtaining one or more height maps;
modifying at least some of the one or more height maps to include at least one artificially generated three-dimensional (3D) defect, thereby generating one or more respective synthetic fault height maps;
applying a first machine learning model to the one or more respective synthetic fault height maps, wherein the first machine learning model is trained to generate, from height maps of a semiconductor specimen, corresponding synthetic images of the semiconductor specimen, thereby obtaining one or more respective synthetic fault images.

12. The computer-implemented method of claim 11, wherein the one or more examination output images include one or more fault-free images; the method comprising:
processing the one or more fault-free images using a height map generation algorithm dedicated for generating, from each image, a respective height map of the semiconductor specimen, thereby obtaining one or more height maps;
applying the first machine learning model to the one or more height maps, thereby obtaining one or more respective synthetic fault-free images.

13. The computer-implemented method of claim 11, wherein generation of synthetic fault images is executed as part of a defects detection process, dedicated for detecting defects in examination output images of a semiconductor specimen; the method comprising executing, as part of the defects detection process:
generating a training dataset from the synthetic fault images and the fault-free images;
utilizing the training dataset for training a second machine learning model dedicated for receiving examination output images of a semiconductor specimen and detecting defects therein.

14. The computer-implemented method of claim 12, wherein generation of synthetic fault images and synthetic fault-free images is executed as part of a defects detection process, dedicated for detecting defects in examination output images of a semiconductor specimen; the method comprising, executing as part of the defects detection process, operations comprising:
generating a training dataset from the synthetic fault images and synthetic fault-free images;
utilizing the training dataset for training a second machine learning model dedicated for receiving examination output images of a semiconductor specimen and detecting defects therein.

15. The computer-implemented method of claim 14 comprising: following training of the second machine learning model, applying a second machine learning model to examination output images of the semiconductor specimen acquired by the semiconductor examination tool, thereby detecting defects in the semiconductor specimens.

16. The computer-implemented method of claim 15, wherein the defects detection process is executed as part of a semiconductor fabrication process for detecting defects in real-time.

17. The computer-implemented method according to claim 15 comprising:
responsive to receiving data indicating that examination output images of a semiconductor specimen contain a type of defect that was not included in a training set used for training the second machine learning model, executing the defects detection process where the at least one artificially generated three-dimensional (3D) defect includes the type of defect, thereby updating the second machine learning model to detect the type of defect, on-the-fly.

18. The computer-implemented method of claim 11, wherein modifying each height map to include at least one artificially generated 3D defect comprises applying procedural generation methods for creating a 3D defect, and implanting the 3D defect in the height maps.

19. The computer-implemented method of claim 11 wherein the examination tool is a Scanning Electron Microscope (SEM), and the examination output images are SEM images of the semiconductor specimen.

20. A non-transitory computer readable storage medium tangibly embodying a program of instructions that, when executed by a computer, cause the computer to perform a method of generating synthetic images of a semiconductor examination tool, obtaining one or more examination output images of a semiconductor specimen acquired by the semiconductor examination tool; the method comprising:
processing the one or more examination output images using a height map generation algorithm dedicated for generating, from each image, a respective height map of the semiconductor specimen, thereby obtaining one or more height maps;
modifying at least some of the one or more height maps to include at least one artificially generated three-dimensional (3D) defect, thereby generating one or more respective synthetic fault height maps;
applying a first machine learning model to the one or more respective synthetic fault height maps, wherein the first machine learning model is trained to generate, from height maps of a semiconductor specimen, corresponding synthetic images of the semiconductor specimen, thereby obtaining one or more respective synthetic fault images.
